(19) United States
(12) Patent Application Publication
(10) Pub. No.: US 2026/0290672 A1
(43) Pub. Date: Sep. 24, 2026

(54) ENERGY TRANSMISSION DEVICE

(71) Applicant: LITE-ON TECHNOLOGY CORPORATION, Taipei (TW)

(72) Inventors: Yao-Ting XIE, Taipei (TW); Yen-An CHEN, Taipei (TW); Bo-Ruei CIOU, Taipei (TW); Yu-Wei LIN, Taipei (TW); De-Jia LU, Taipei (TW); Chen CHEN, Taipei (TW)

(21) Appl. No.: 19/281,779

(22) Filed: Jul. 28, 2025

Related U.S. Application Data
(60) Provisional application No. 63/774,813, filed on Mar. 20, 2025.

(30) Foreign Application Priority Data
Jun. 27, 2025 (CN) 202521339422.1

(51) Int. Cl. H01F 27/28; H01F 27/02; H01F 27/24; H02J 50/10

(52) U.S. Cl. CPC H01F 27/28; H01F 27/02; H01F 27/24; H02J 50/10

(57) ABSTRACT

An energy transmission device includes an energy induction element and a coil. The energy induction element includes a first induction portion and a second induction portion. The second induction portion is disposed adjacent to the first induction portion. The coil is disposed adjacent to the energy induction element. The first induction portion and the second induction portion are made of different materials.

This application claims the benefit of U.S. provisional application Ser. No. 63/774,813, filed Mar. 20, 2025, the subject matter of which is incorporated herein by reference, claims the benefit of People's Republic of China application Serial No. 202521339422.1, filed on Jun. 27, 2025, the subject matter of which is incorporated herein by reference.

### BACKGROUND OF THE INVENTION

### Field of the Invention

The invention relates in general to an energy transmission device.

### Description of the Related Art

A common approach to improving iron loss in current energy transmission devices (for example, wireless charging modules) is to select low-loss materials to reduce iron loss. However, this approach may not necessarily satisfy the required inductance of the design, and sometimes the inductance must be sacrificed to achieve this.

### SUMMARY OF THE INVENTION

According to an embodiment of the present invention, an energy transmission device is provided. The energy transmission device includes an energy induction element and a coil. The energy induction element includes a first induction portion and a second induction portion. The second induction portion is disposed adjacent to the first induction portion. The coil is disposed adjacent to the energy induction element. The first induction portion and the second induction portion are different in material.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of an energy transmission system according to an embodiment of the present invention;

FIG. 2A is a schematic diagram of an energy transmission device according to an embodiment of the present invention;

FIG. 2B is a schematic diagram of the energy transmission device in FIG. 2A omitting a first cover;

FIG. 2C is a schematic diagram of the energy transmission device in FIG. 2A omitting the first cover and a coil carrier;

FIGS. 3A and 3B are schematic diagrams of exploded views of the energy transmission device in FIG. 2A at different viewing angles;

FIG. 4 is a schematic diagram of a cross-sectional view of the energy transmission device in FIG. 2A along a direction 4-4′;

FIG. 5A is a characteristic diagram of the magnetic flux density, the magnetic field intensity, the iron loss and the terminal current of the energy transmission device in FIG. 2A;

FIG. 5B is a relationship diagram of the thickness of the second induction portion of the energy transmission device in FIG. 2A, the coupling coefficient and the self-inductance;

FIG. 5C is a relationship diagram of the thickness of the second induction portion of the energy transmission device in FIG. 2A and the loss; and

FIG. 6 is a schematic diagram of an energy transmission device according to another embodiment of the present invention.

### DETAILED DESCRIPTION OF THE INVENTION

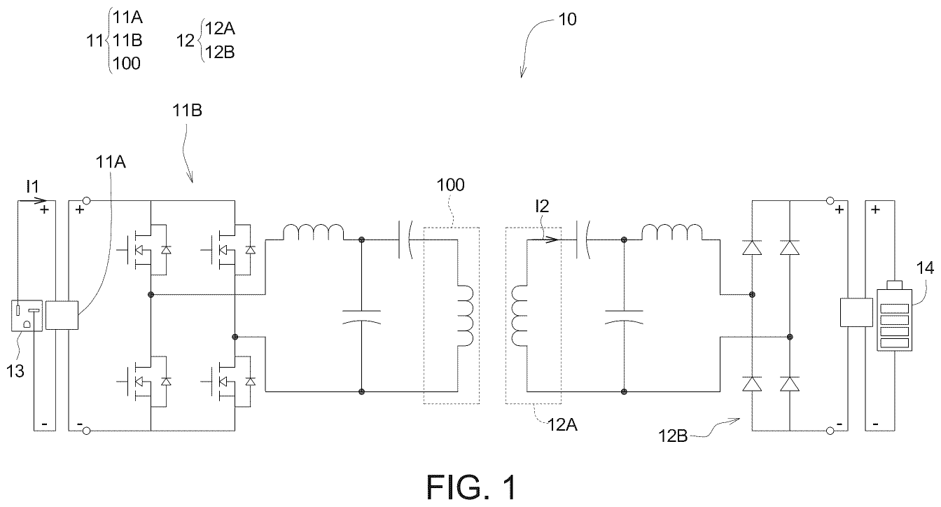

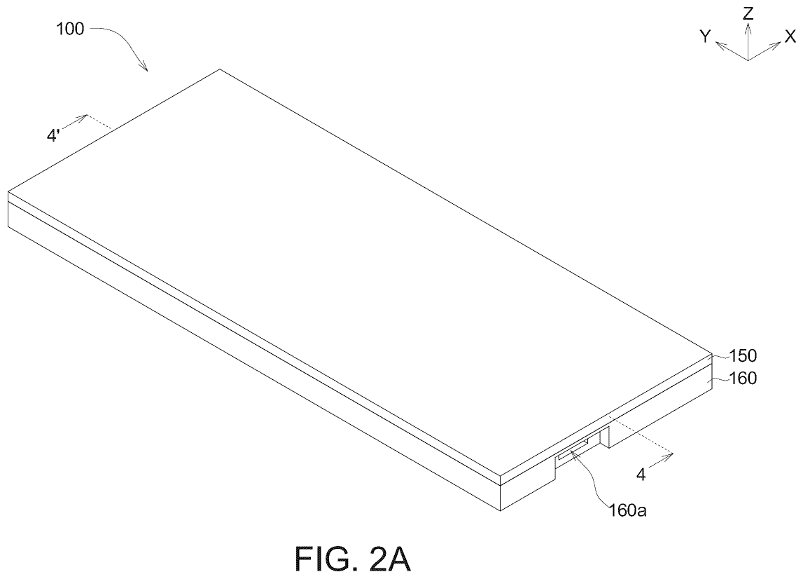

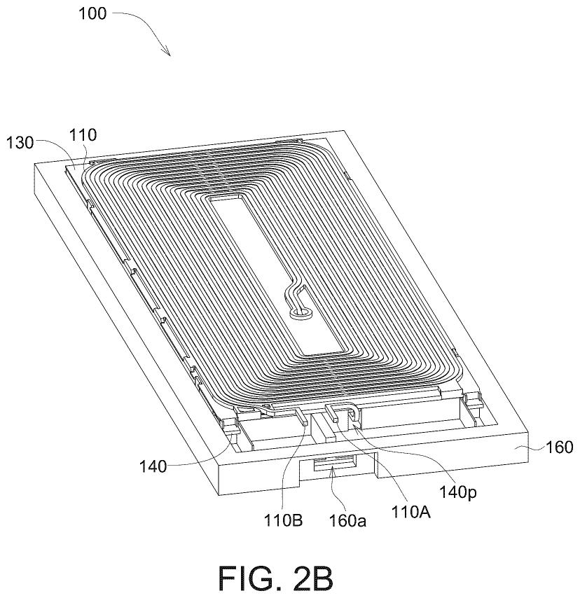

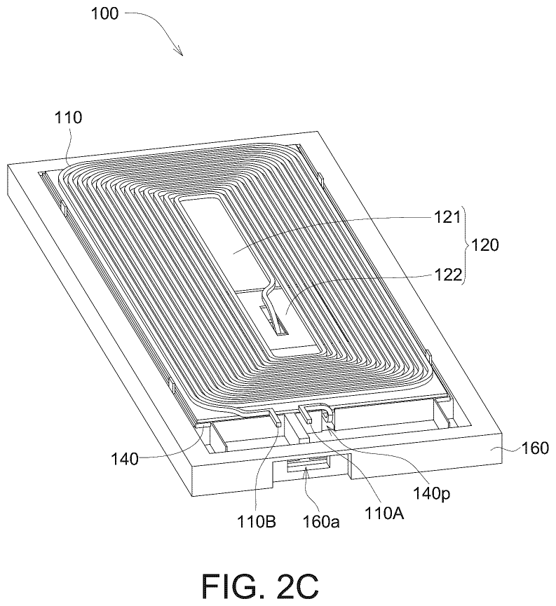

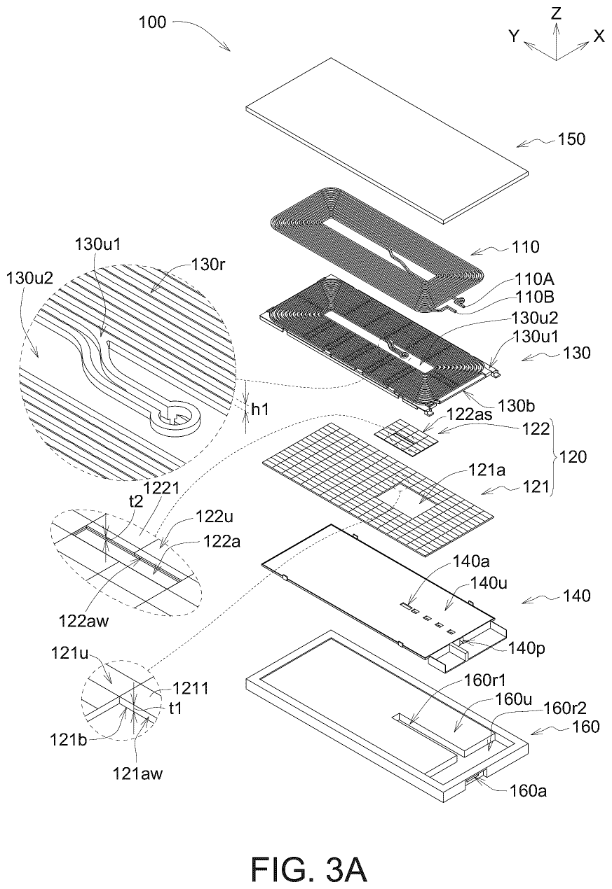

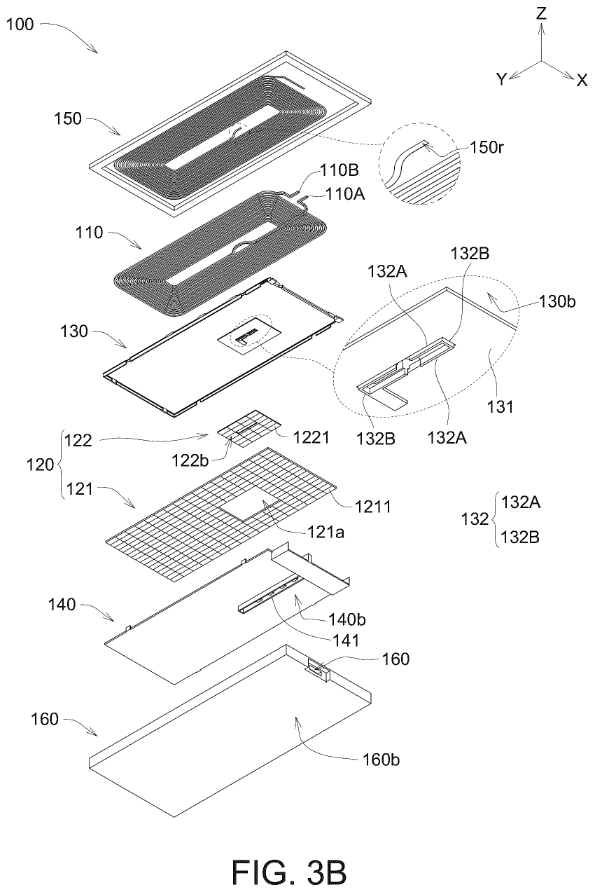

Referring to FIGS. 1 to 4, FIG. 1 is a schematic diagram of an energy transmission system 10 according to an embodiment of the present invention, FIG. 2A is a schematic diagram of an energy transmission device 100 according to an embodiment of the present invention, FIG. 2B is a schematic diagram of the energy transmission device 100 in FIG. 2A omitting a first cover 150, FIG. 2C is a schematic diagram of the energy transmission device 100 in FIG. 2A omitting the first cover 150 and a coil carrier 130, FIGS. 3A and 3B are schematic diagrams of exploded views of the energy transmission device 100 in FIG. 2A at different viewing angles, and FIG. 4 is a schematic diagram of a cross-sectional view of the energy transmission device 100 in FIG. 2A along a direction 4-4′.

As shown in FIG. 1, the energy transmission system 10 is, for example, a wireless charging system which includes a power supply module 11 and a power receiving module 12, wherein the power supply module 11 may be electrically connected to a power source 13, and the power receiving module 12 may be electrically connected to a battery 14. The power supply module 11 and the power receiving module 12 may perform energy transmission by using, for example, wireless communication technology. For example, the power supply 13 supplies a current 11 to the power supply module 11, and the current 11 generates a magnetic field in the power supply module 11. The power receiving module 12 may sense the magnetic field and generate a current 12 to be stored in the battery 14. The power supply module 11 includes a PFC (Power Factor Correction) device 11A, a first conversion device 11B and an energy transmission device 100, and the power receiving module 12 includes an energy induction device 12A and a second conversion device 12B.

As shown in FIG. 1, the energy transmission device 100 and the energy induction device 12A are, for example, wireless charging devices. In the present embodiment, the energy transmission device 100 may be referred to as a primary-side induction device, and the energy induction device 12A may be referred to as a secondary-side induction device. The energy transmission device 100 and the energy induction device 12A include the same or corresponding structural features, and the following is an embodiment of the energy transmission device 100.

As shown in FIGS. 3A and 3B, the energy transmission device 100 includes a coil 110, an energy induction element 120, the coil carrier 130, an induction carrier 140, the first cover 150, and a second cover 160. The coil 110, the energy induction element 120, the coil carrier 130, and an induction carrier 140 are disposed between the first cover 150 and the second cover 160.

In the present embodiment, the energy induction element 120 is, for example, a magnetic core. The magnetic core is a piece of magnetic material with high magnetic permeability, and it may be used to limit and guide the magnetic field in electrical, electromechanical and magnetic devices (for example, electromagnets, transformers, motors, generators and inductors). Compared with the case without the magnetic core, the magnetic core may increase the magnetic field strength in the electromagnetic coil by hundreds of times. The energy induction element 120 includes a first induction portion 121 and a second induction portion 122. The second induction portion 122 is disposed adjacent to the first induction portion 121. The coil 110 is disposed adjacent to the energy induction element 120. The first induction portion 121 and the second induction portion 122 are different in material. As a result, the total loss of the energy transmission device 100 may be reduced. In other words, the magnetic permeability of the first induction portion 121 is less than the magnetic permeability of the second induction portion 122.

As shown in FIGS. 3A and 3B, the coil 110 is, for example, a coil of a charging device. The coil 110 is made of, for example, copper. The coil 110 may be wound into a plurality of turns and has a first end 110A and a second end 110B. The first end 110A and the second end 110B may be electrically connected to the first conversion device 11B in FIG. 1.

In an embodiment, the first induction portion 121 may be, for example, made of a ferromagnetic metal (for example, iron) or a ferrimagnetic compound (for example, ferrite), and the second induction portion 122 is, for example, formed by stacking at least one magnetic patch. The magnetic patch is made of, for example, a nanocrystalline magnetic core. The nanocrystalline magnetic core is, for example, composed of iron, chromium, copper, silicon and boron, which make these specific alloy components as amorphous by using a rapid quenching technique, and then produce nano-sized grains by performing heat treatment. Nanocrystalline magnetic cores exhibit excellent magnetic properties and temperature stability. Due to the nanostructure of nanocrystalline magnetic cores, which combine the advantages of silicon steel, permalloy and ferrite. Nanocrystalline magnetic cores have high magnetic permeability, and it may improve the inductance, so that the same inductance may be achieved in a smaller volume.

As shown in FIGS. 3A and 3B, the first induction portion 121 has a first thickness t1, and the second induction portion 122 has a second thickness t2. In an embodiment, the second thickness t2 may not be greater than the first thickness t1. For example, the second thickness t2 is equal to or less than the first thickness t1. In another embodiment, depending on the design requirements, the second thickness t2 may be equal to or even greater than the first thickness t1.

As shown in FIGS. 3A, 3B and 4, the first induction portion 121 has a through hole 121a and has a first surface 121u and a second surface 121b opposite to each other. The second induction portion 122 may be accommodated in the through hole 121a. In the present embodiment, when the first induction portion 121 and the second induction portion 122 are combined, at least one portion of the second induction portion 122 is located in the through hole 121a of the first induction portion 121, and at least one portion of an outer lateral surface 122as of the second induction portion 122 may be in contact with at least one portion of an inner lateral surface 121aw of the through hole 121a of the first induction portion 121. For example, as shown in FIG. 3A, the first induction portion 121 may be disposed around an periphery of the second induction portion 122.

As shown in FIGS. 3A and 3B, the second induction portion 122 may be located between the first surface 121u and the second surface 121, that is, the second induction portion 122 may not protrude beyond the first surface 121u and the second surface 121. The second induction portion 122 has a third surface 122u and a fourth surface 122b opposite to the third surface 122u. In an embodiment, the third surface 122u of the second induction portion 122 may be substantially aligned with (for example, flush with) the first surface 121u of the first induction portion 121, and/or the fourth surface 122b of the second induction portion 122 may be substantially aligned with (for example, flush with) the second surface 121b of the first induction portion 121. In another embodiment, the third surface 122u of the second induction portion 122 is spaced from the first surface 121u of the first induction portion 121 by a distance, and/or the fourth surface 122b of the second induction portion 122 is spaced from the second surface 121b of the first induction portion 121 by a distance.

As shown in FIGS. 3A and 3B, the second induction portion 122 has a through hole 122a. The aforementioned coil 110 may pass through the through hole 122a. In the present embodiment, the through hole 122a does not extend to the outer lateral surface 122as of the second induction portion 122, that is, the through hole 122a does not expose an opening from the outer lateral surface 122as of the second induction portion 122. In another embodiment, the through hole 122a may be formed between the first induction portion 121 and the second induction portion 122, that is, the through hole 122a is formed by being surrounded by the first induction portion 121 and the second induction portion 122.

In the present embodiment, due to the design of the through hole 122a, a portion of the coil 110 may not overlap with another portion of the coil 110 up and down (if the overlap occurs, additional copper loss will be generated), so the energy transmission device 100 may be suitable for high-power (for example, kilowatt (KW) level) energy transmission. In addition, when the coil 110 passes through the through hole 122a, the magnetic flux, generated by current traveling through, causes the magnetic core around the through hole 122a to be partially saturated, and the magnetic core will generate high loss when saturated. However, the material design of the second induction portion 122 of the disclosed embodiment may improve the aforementioned high loss problem.

As shown in FIGS. 3A and 3B, the first induction portion 121 includes a plurality of first induction patches 1211. These first induction patches 1211 may be connected side by side along XY-plane. The X, Y and Z axes shown in the figure are, for example, perpendicular to each other. The through hole 121a is formed by being surrounded by a plurality of first induction patches 1211. In another embodiment, the first induction portion 121 may be a single induction patch having the through hole 121a.

As shown in FIGS. 3A and 3B, the first induction portion 121 includes a plurality of second induction patches 1221. These second induction patches 1221 may be connected side by side along XY-plane. These second induction patches 1221 may be stacked into an N-layer structure along Z-axis, where N is, for example, a positive integer between 1 and 10, or even greater or less. In an embodiment, the second induction patch 1221 is, for example, a magnetic patch. In an embodiment, the thickness of one second induction patch 1221 (for example, along Z-axis) is, for example, 0.365 millimeters (mm), even greater, or even less.

As shown in FIGS. 3A and 4, the coil carrier 130 may carry the coil 110. The coil carrier 130 has a first surface 130u1, a second surface 130u2, a third surface 130b, a first groove 130r and a through hole 130a. The first groove 130r extends from the first surface 130u1 to the second surface 130u2, and the coil 110 may be accommodated in the first groove 130r. The through hole 130a may extend from the first surface 130u1 to the third surface 130b, that is, the through hole 130a penetrates the coil carrier 130, so that a portion 111 of the coil 110 may extend from the first groove 130r to the side of the third surface 130b through the through hole 130a. In an embodiment, the through hole 130a has an inner lateral surface 130aw, and the inner lateral surface 130aw is, for example, an inclined surface, which may guide the coil 110 to pass through the through hole 130a. Furthermore, the inner lateral surface 130aw may extend obliquely from the second surface 130u2 toward the third surface 130b. As a result, the portion 111 of the coil 110 may smoothly pass through the through hole 130a by the inclined characteristics of the inner lateral surface 130aw.

As shown in FIGS. 3B and 4, the coil carrier 130 further includes at least one protrusion 131. The protrusion 131 is connected to the third surface 130b of the coil carrier 130 and protrudes relative to the third surface 130b. The protrusion 131 may constrain the displacement of the second induction portion 122. For example, the protrusion 131 may extend into the through hole 121a of the first induction portion 121 and be adjacent to the third surface 122u of the second induction portion 122 to constrain a relative displacement of the second induction portion 122 and the coil carrier 130 along Z-axis. In the present embodiment, the protrusion 131 may abut against the third surface 122u of the second induction portion 122 to fix the relative position of the second induction portion 122 and the coil carrier 130 along Z-axis.

As shown in FIGS. 3B and 4, the coil carrier 130 further includes at least one limiting portion 132 which is connected to the third surface 130b and protrudes relative to the third surface 130b. When the coil carrier 130 is combined with the energy induction element 120, the limiting portion 132 is located in the through hole 122a of the second induction portion 122 and adjacent to the inner lateral surface 122aw of the through hole 122a to constrain the relative displacement of the second induction portion 122u along XY-plane.

As shown in FIGS. 3B and 4, in the present embodiment, these limiting portions 132 include at least two first limiting portions 132A and two second limiting portions 132B. The two first limiting portions 132A may be disposed relative to each other along X-axis (for example, a first direction), and may constrain the relative displacement of the second induction portion 122 and the coil carrier 130 along +/−X axis. The other two second limiting portions 132B may be disposed relatively along Y-axis (for example, a second direction) to constrain the relative displacement of the second induction portion 122 and the coil carrier 130 along +/−Y axis. In an embodiment, the first limiting portion 132A and the second limiting portion 132B may abut against the inner lateral surface 122aw of the through hole 122a of the second induction portion 122 to fix the relative position of the second induction portion 122 and the coil carrier 130 along XY-plane.

As shown in FIGS. 2B, 2C, 3A and 4, the induction carrier 140 may carry the energy induction component 120. For example, the induction carrier 140 has a through hole 140a and a fifth surface 140u and a sixth surface 140b opposite to the fifth surface 140u, wherein the through hole 140a extends from the fifth surface 140u to the sixth surface 140b. The aforementioned coil 110 may pass through the through hole 140a to extend to the side of the sixth surface 140b. The induction carrier 140 has an opening 140p, and the first end 110A of the coil 110 may extend to the outside of the induction carrier 140 through the opening 140p. Furthermore, the induction carrier 140 further includes a limiting wall 141 which is connected to the sixth surface 140b and protrudes relative to the sixth surface 140b to constrain the relative displacement of the coil 110 and the induction carrier 140.

As shown in FIGS. 3A, 3B and 4, the first cover 150 has a second groove 150r. The coil 110 may be disposed between the first groove 130r of the coil carrier 130 and the second groove 150r of the first cover 150. The second groove 150r of the first cover 150 overlaps with the first groove 130r of the coil carrier 130 along Z-axis. Thus, when an outer diameter d1 of the coil 110 is greater than a depth h1 of the first groove 130r, the coil 110 may be partially accommodated in the second groove 150r, thereby avoiding interference between the coil 110 and the solid material of the first cover 150. In another embodiment, if the outer diameter d1 of the coil 110 is not greater than the depth h1 of the first groove 130r, the first cover 150 may omit the second groove 150r.

As shown in FIGS. 2B, 2C, 3A and 4, the second cover 160 has a first recess 160r1, a second recess 160r2, a seventh surface 160u and an eighth surface 160b opposite to the seventh surface 160u and an opening 160a. The first recess 160r1 and the second recess 160r2 extend from the seventh surface 160u toward the eighth surface 160b. The coil 110 located on the side of the third surface 130b of the coil carrier 130 may be accommodated in the first recess 160r1 to avoid excessive interference between the coil 110 and the solid material of the second cover 160. The second recess 160r2 connects the first recess 160r1 with the opening 160a. The coil 110 may extend outside the second cover 160 through the opening 160a. For example, the first end 110A and the second end 110B of the coil 110 may extend outside the energy transmission device 100 through the opening 160a.

As shown in Table 1 below, K is the coupling coefficient between the primary-side induction device and the secondary-side induction device, and the coupling coefficient is, for example, a real number ranging between 0 and 1 (including end points). If the coupling coefficient is closer to 1, it means that the coupling between the two inductors is tighter and the energy transmission efficiency is higher; if the coupling coefficient is 0, it means that there is no mutual inductance between the two inductors and the two inductors are independent. L_{GA} is the self-inductance of the primary-side induction device (hereinafter referred to as “primary-side self-inductance”), and L_{VA} is the self-inductance of the secondary-side induction device (hereinafter referred to as “secondary-side self-inductance”). The units of the primary-side self-inductance L_{GA}, the secondary-side self-inductance L_{VA} and the mutual inductance are, for example, H, while the units of the iron loss, the copper loss and the total loss are, for example, watts, and the total loss is equal to the sum of iron loss and copper loss.

TABLE 1

| | | | mutual | | iron | copper | total |
|---|---|---|---|---|---|---|---|
| | L_{GA} | L_{VA} | inductance | K | loss | loss | loss |
| control | 68.13 | 23.22 | 24.63 | 0.62 | 62.25 | 21.32 | 83.57 |
| group | | | | | | | |
| comparative | 70.24 | 25.26 | 24.70 | 0.59 | 87.4 | 20.52 | 107.96 |
| example 1 | | | | | | | |
| embodiment | 68.04 | 23.45 | 24.45 | 0.618 | 58.20 | 21.11 | 79.31 |
| comparative | 66.37 | 22.15 | 24.27 | 0.63 | 35.49 | 21.64 | 57.13 |
| example 2 | | | | | | | |

The self-inductance L_{GA}, the self-inductance L_{VA}, the mutual inductance, the coupling coefficient K and/or the total loss may be changed by designing the thickness of the second induction portion 122, as further described below.

In comparative example 1, the thickness of the second induction portion 122 maintains the same thickness as the first induction portion 121, such a thickness design causes the primary-side self-inductance L_{GA} and the secondary-side self-inductance L_{VA} to be higher than that of the control group (because the magnetic patch has a high magnetic permeability, the inductance may be increased, so the same inductance may be achieved in a smaller volume).

In the embodiment, a thinner magnetic patch than the control group is used, so the primary-side self-inductance L_{GA} and the secondary-side self-inductance L_{VA} are lower than that of the comparative example 1, but close to the control group (the self-inductance of the control group is, for example, the design goal), and the total loss is lower than that of the comparative example 1 and that of the control group, indicating that the total loss is still improved (the total loss is lower than that of the control group, indicating that the total loss is improved).

In comparative example 2, a thinner magnetic patch than that of the embodiment is used, so the primary-side self-inductance L_{GA} and the secondary-side self-inductance L_{VA} are lower than that of the embodiment, and the total loss is lower than the embodiment, which indicates that the thickness of the magnetic patch is insufficient.

In summary, in the embodiment, by designing the thickness of the second induction portion 122, the primary-side self-inductance L_{GA} and the secondary-side self-inductance L_{VA} may be close to that of the control group (meeting the inductance design goal), and the total loss is lower (total loss is improved). In other words, by designing the thickness of the second induction portion 122, a technical effect of lower total loss may be obtained under the same or similar self-inductance design goal.

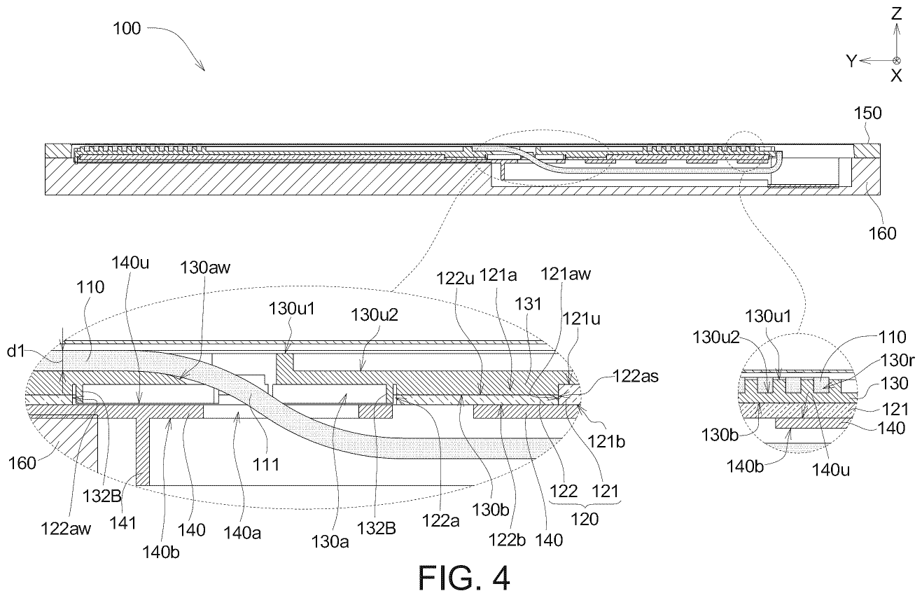

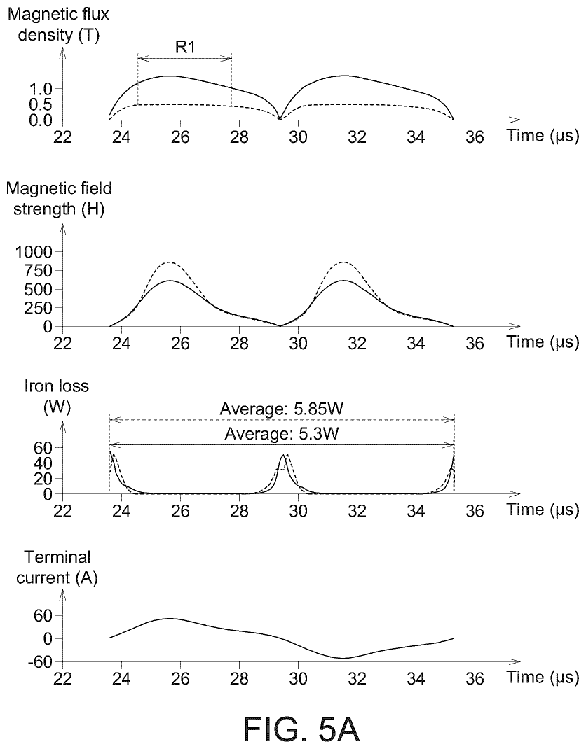

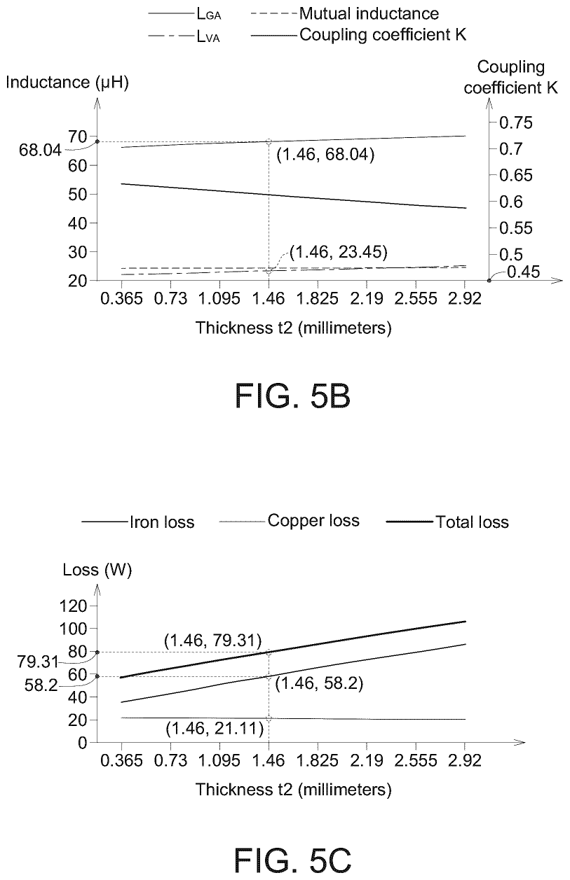

Referring to FIGS. 5A to 5C, FIG. 5A is a characteristic diagram of the magnetic flux density, the magnetic field intensity, the iron loss and the terminal current of the energy transmission device 100 in FIG. 2A, FIG. 5B is a relationship diagram of the thickness of the second induction portion of the energy transmission device 100 in FIG. 2A, the coupling coefficient and the self-inductance, and FIG. 5C is a relationship diagram of the thickness of the second induction portion of the energy transmission device 100 in FIG. 2A and the loss.

The solid line in FIG. 5A shows the characteristic diagram of the magnetic flux density, the magnetic field strength and the iron loss of a region of the second induction portion 122 of the energy transmission device 100 (for example, one of the second induction patches 1221 adjacent to the through hole 122a), while the dotted line shows the characteristic diagram of the magnetic flux density, the magnetic field strength and the iron loss of the energy transmission device of the control group (for example, the whole of the energy induction portion is made of the same material), wherein the terminal current may be used as a comparative reference value to prove that the embodiment and the control group are compared under the same conditions.

The second induction portion 122 of the energy transmission device 100 of the embodiment of the present invention is small in volume, so it may reduce the iron loss, thereby reducing the total loss.

As shown in the flux density change (dashed line) of the energy transmission device of the control group in FIG. 5A, after the magnetic core reaches the saturation flux density (for example, in an interval R1, the flux is saturated and the flux density change tends to be flat), the magnetic field strength change (ΔB) becomes smaller, the hysteresis loss decreases, and the overall iron loss decreases. However, when the current decreases, the magnetic field strength change begins to increase, and the iron loss increases significantly compared to the saturation. In other words, if the flux density reaches the saturation flux density of the magnetic core, a large loss will occur. As shown in the flux density change (solid line) of the energy transmission device 100 in FIG. 5A, due to the design of the second induction portion 122, the magnetic flux density of the magnetic core is lower than the saturation flux density, so the iron loss may be reduced. In comparison, compared with the average iron loss of the energy transmission device of the control group being about 5.85 watt (W), the average iron loss of the energy transmission device 100 of the embodiment of the present invention may be reduced to about 5.3 W.

As shown in FIG. 5B, the horizontal axis is the second thickness t2 of the second induction portion 122, where “0.365 mm” is the thickness of one second induction patch 1221 in the second induction portion 122, and the scale value of the horizontal axis may be converted into the number of stacked layers of the second induction portion 122. The coupling coefficient K decreases as the second thickness t2 of the second induction portion 122 increases, while the primary-side self-inductance L_{GA} and the secondary-side self-inductance L_{VA} increase as the second thickness t2 of the second induction portion 122 increases. In an embodiment, when the second thickness t2 of the second induction portion 122 is equal to 1.46 mm, the primary-side self-inductance L_{GA} of approximately 68.04 μH and the secondary-side self-inductance L_{VA} of approximately 23.45 μH may be obtained, which is close to the primary-side self-inductance and the secondary-side self-inductance of the control group (as shown in Table 1), and meets the self-inductance design goal.

As shown in FIG. 5C, the iron loss increases with the increase of the second thickness t2 of the second induction portion 122, but the copper loss decreases with the increase of the second thickness t2 of the second induction portion 122. Overall, the total loss still increases with the increase of the second thickness t2 of the second induction portion 122. When the second thickness t2 of the second induction portion 122 is equal to 1.46 mm, the total loss of about 79.31 W may be obtained, which is lower than the total loss of the control group in Table 1, and thus proves that the design of the second induction portion 122 of the disclosed embodiment may reduce the loss.

In summary, by designing the thickness of the second induction portion 122, both “the primary-side self-inductance L_{GA} and the secondary-side self-inductance L_{VA} meet the inductance design goal” and “reduce the total loss” may be satisfied. In another embodiment, if the primary-side self-inductance L_{GA} and the secondary-side self-inductance L_{VA} meet the inductance design goal, but the total loss is not reduced, a thinner second induction patch 1221 may be selected. In the present embodiment, when the second thickness t2 of the second induction portion 122 is equal to 1.46 mm, the first thickness t1 of the first induction portion 121 is, for example, 3 mm. In other words, a ratio of the second thickness t2 of the second induction portion 122 to the first thickness t1 of the first induction portion 121 (i.e., t2/t1) is, for example, not greater than 1, which may simultaneously meet the requirements of “the primary-side self-inductance L_{GA} and the secondary-side self-inductance L_{VA} meet the inductance design goal” and “reduce the total loss”. In an embodiment, the ratio of the second thickness t2 to the first thickness t1 may range between 0.4 and 0.9.

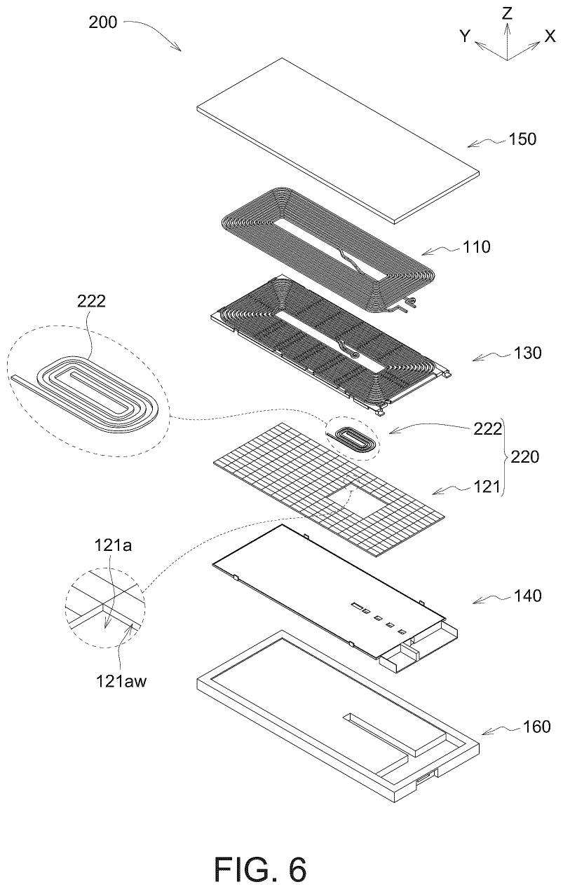

Referring to FIG. 6, FIG. 6 is a schematic diagram of an energy transmission device 200 according to another embodiment of the present invention. The energy transmission device 200 includes the coil 110, an energy induction element 220, the coil carrier 130, the induction carrier 140, the first cover 150 and the second cover 160. The coil 110, the energy induction element 220, the coil carrier 130 and the induction carrier 140 are disposed between the first cover 150 and the second cover 160. The energy transmission device 200 has the technical features similar to or the same as that of the energy transmission device 100, and at least one difference is that the energy induction element 220 is different from that of the energy induction element 120 in structure.

As shown in FIG. 6, the energy induction element 220 is, for example, a magnetic core. The energy induction element 220 includes the first induction portion 121 and a second induction portion 222. The second induction portion 222 is disposed adjacent to the first induction portion 121. For example, the second induction portion 222 may be disposed in the through hole 121a of the first induction portion 121. The second induction portion 222 may be in contact with or not in contact with the inner lateral surface 121aw of the through hole 121a (i.e., spaced from each other). The first induction portion 121 and the second induction portion 222 are different in material. As a result, the total loss of the energy transmission device 200 may be reduced. The material, structure and thickness design of the second induction portion 222 are the same or similar to those of the second induction portion 122, and they will not be repeated here. Unlike the second induction portion 122, the second induction portion 222 may be extended into a multi-turn shape or a spiral shape.

In summary, an embodiment of the present invention proposes an energy transmission device which includes at least one energy induction element, for example, a magnetic core. The energy induction element includes two portions, wherein the two portions are different in material. Through material design, the dual effects of “the primary-side self-inductance and the secondary-side self-inductance meet the inductance design goal” and “reduce the total loss” may be obtained. In an embodiment, one of the two portions may be made of, for example, a ferromagnetic metal (for example, iron) or a ferrimagnetic compound (for example, ferrite), and the other of the two portions may be made of, for example, at least one magnetic patch stacked, wherein the magnetic patch is made of, for example, a nanocrystalline magnetic core. In an embodiment, one of the two portions may be at least partially located in the through hole of the other of the two portions. In an embodiment, the two portions of the energy induction element may be different in thickness, or may be equal. By designing the thickness of the two parts of the energy induction element, it is possible to simultaneously meet the requirements of “the primary-side self-inductance and the secondary-side self-inductance meet the inductance design goal” and “reduce the total loss”.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. An energy transmission device, comprising:
an energy induction element, comprising:
a first induction portion; and
a second induction portion, disposed adjacent to the first induction portion; and
a coil, disposed adjacent to the energy induction element;
wherein the first induction portion and the second induction portion are different in material.

2. The energy transmission device as claimed in claim 1, wherein the second induction portion comprises a plurality of induction patches, and the induction patches are stacked into at least two layers.

3. The energy transmission device as claimed in claim 1, wherein the first induction portion is made of ferrite, and the second induction portion is a nanocrystalline magnetic core.

4. The energy transmission device as claimed in claim 1, wherein the first induction portion has a first thickness, and the second induction portion has a second thickness, wherein the second thickness is less than the first thickness.

5. The energy transmission device as claimed in claim 1, wherein the second induction portion has a through hole, and the coil passes through the through hole.

6. The energy transmission device as claimed in claim 1, wherein the first induction portion and the second induction portion surround a through hole, and the coil passes through the through hole.

7. The energy transmission device as claimed in claim 1, wherein the first induction portion has a through hole, and the second induction portion is located in the through hole and in contact with an inner lateral surface of the through hole.

8. The energy transmission device as claimed in claim 1, wherein the first induction portion has a through hole, and the second induction portion is located in the through hole and is not in contact with an inner lateral surface of the through hole.

9. The energy transmission device as claimed in claim 8, wherein the second induction portion extends into a spiral shape.

10. The energy transmission device as claimed in claim 1, wherein the second induction portion has a through hole, and the energy transmission device further comprises:
a coil carrier, carrying the coil and comprising a limiting portion, wherein the limiting portion is located in the through hole of the second induction portion and adjacent to an inner lateral surface of the through hole.

11. The energy transmission device as claimed in claim 1, wherein the second induction portion has a through hole, and the energy transmission device further comprises:
a coil carrier, carrying the coil and comprising:
two first limiting portions, disposed oppositely along a first direction;
two second limiting portions, disposed oppositely along a second direction;
wherein the first direction and the second direction are perpendicular to each other.

12. The energy transmission device as claimed in claim 1, further comprising:
an induction carrier, carrying the energy induction portion and having a through hole;
wherein the coil passes through the through hole of the induction carrier.

13. The energy transmission device as claimed in claim 1, further comprising:
a coil carrier, carrying the coil and having a first groove; and
a first cover, having a second groove;
wherein the coil is located between the first groove and the second groove.

14. The energy transmission device as claimed in claim 1, further comprising:
a second cover, having a recess and an opening, wherein the opening communicating with the recess;
wherein the coil is located in the recess and extends an outside of the second cover through the opening.

15. The energy transmission device as claimed in claim 1, further comprising:
a coil carrier, carrying the coil and having a through hole, wherein the through hole has an inclined surface, the inclined surface is configured to guide the coil through the through hole.
